(19) United States
(12) Patent Application Publication
(10) Pub. No.: US 2022/0156611 A1
(43) Pub. Date: May 19, 2022

(54) METHOD AND APPARATUS FOR ENTERING INFORMATION, ELECTRONIC DEVICE, COMPUTER READABLE STORAGE MEDIUM

(71) Applicant: Beijing Baidu Netcom Science Technology Co., Ltd., Beijing (CN)

(72) Inventors: Tinghui ZHAO, Beijing (CN); Shichen SHAO, Beijing (CN); Yongheng LI, Beijing (CN); Yuqing SUN, Beijing (CN); Fei XU, Beijing (CN); Chengzhi FANG, Beijing (CN)

(21) Appl. No.: 17/590,677

(22) Filed: Feb. 1, 2022

(30) Foreign Application Priority Data
Jun. 30, 2021 (CN) 202110748343.6

(51) Int. Cl. G06N 5/04

(52) U.S. Cl. CPC G06N 5/04

(57) ABSTRACT

A method and apparatus for entering information are provided. The method includes: clustering acquired to-be-identified materials to obtain a question-and-answer material; performing corpus-processing on the question-and-answer material to obtain a question-and-answer corpus pair, the question-and-answer corpus pair comprising at least one question and an answer to each question of the at least one question; performing title determination on the question-and-answer corpus pair to obtain at least one title and an answer corresponding to each title of the at least one title; and storing the at least one title and an answer corresponding to each title of the at least one title in a question bank in a structured manner.

### CROSS-REFERENCE TO RELATED APPLICATIONS

The present application claims the priority of Chinese Patent Application No. 202110748343.6, titled “METHOD AND APPARATUS FOR ENTERING INFORMATION, ELECTRONIC DEVICE, COMPUTER READABLE STORAGE MEDIUM”, filed on Jun. 30, 2021, the content of which is incorporated herein by reference in its entirety.

### TECHNICAL FIELD

The present disclosure relates to a field of computing technology, in particular to technical fields of image processing, database, natural language processing, deep learning, etc., and more particular to a method and apparatus for entering information, an electronic device, a computer readable medium, and a computer program product.

### BACKGROUND

In a library-based question-search system for college students, based on a massive question bank in the library, as well as a high-correlation and a multi-feature matching strategy, it is possible for the college students to search for answers. A content richness for a question bank for college students determines a recall rate and an accuracy of the matching strategy.

### SUMMARY

A method and apparatus for entering information, an electronic device, a computer readable medium, and a computer program product are provided.

According to a first aspect, a method for entering information is provided, the method including: clustering acquired to-be-identified materials to obtain a question-and-answer material; performing corpus-processing on the question-and-answer material to obtain a question-and-answer corpus pair, the question-and-answer corpus pair comprising at least one question and an answer to each question of the at least one performing title determination on the question-and-answer corpus pair to obtain at least one title and an answer corresponding to each title of the at least one title; and storing the at least one title and an answer corresponding to each title of the at least one title in a question bank in a structured manner.

According to a second, an apparatus for entering information is provided, the apparatus including: a clustering unit, configured to cluster acquired to-be-identified materials to obtain a question-and-answer material; a processing unit, configured to perform corpus-processing on the question-and-answer material to obtain a question-and-answer corpus pair, the question-and-answer corpus pair comprising at least one question and an answer to each question of the at least one question; a determination unit, configured to perform title determination on the question-and-answer corpus pair to obtain at least one title and an answer corresponding to each title of the at least one title; and selecting, for each title in the at least one title, an answer to the title from the question-and-answer corpus pair.

In a third aspect, a computer-readable medium storing a computer program thereon is provided, where the program, when executed by a processor, implements the method as described in any one of the embodiments of the first aspect.

It should be understood that the content described in this section is not intended to identify key or important features of the embodiments of the present disclosure, nor is it intended to limit the scope of the present disclosure. Other features of the present disclosure will be easily understood through the following specification.

### BRIEF DESCRIPTION OF THE DRAWINGS

Accompanying drawings are used to better understand the present solution and do not constitute a limitation to the present disclosure, in which:

FIG. 1 is a flowchart of an embodiment of a method for entering information according to the present disclosure;

FIG. 2 is a flowchart of another embodiment of the method for entering information according to the present disclosure;

FIG. 3 is a flowchart of an embodiment of a method for performing title determination on a question-and-answer corpus pair in an embodiment of the present disclosure;

FIG. 4 is a schematic structural diagram of an embodiment of an apparatus for entering information according to the present disclosure; and

FIG. 5 is a block diagram of an electronic device used to implement the method for entering information according to an embodiment of the present disclosure.

### DETAILED DESCRIPTION OF EMBODIMENTS

The following describes exemplary embodiments of the present disclosure in conjunction with the accompanying drawings, which includes various details of the embodiments of the present disclosure to facilitate understanding, and they should be considered as merely exemplary. Therefore, those of ordinary skill in the art should recognize that various changes and modifications may be made to the embodiments described herein without departing from the scope and spirit of the present disclosure. Also, for clarity and conciseness, descriptions of well-known functions and structures are omitted in the following description.

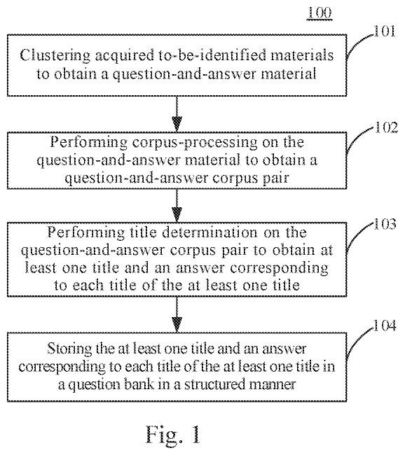

FIG. 1 shows a flow 100 of an embodiment of a method for entering information according to the present disclosure. The method for entering information includes the following steps.

Step 101, clustering acquired to-be-identified materials to obtain a question-and-answer material.

In the present embodiment, an executing body on which the method for entering information operates may acquire the to-be-identified materials from a question-asking community in real time. The question-asking community is a place where different users ask and answer questions. By acquiring the question-and-answer materials from the question-asking community for processing, titles and answers of respective titles in a question bank may be automatically supplemented.

The to-be-identified materials may be some questions raised by a user on his/her current academic stage (such as university, middle school, or elementary school) and a current major type (science, mathematics, chemistry, etc.) and answers to these questions. The to-be-identified materials may be information uploaded by a user, and a form of a to-be-identified material is not limited to any one or more of an images, a text, and a speech.

In the present embodiment, clustering the to-be-identified materials includes: for a question, in the to-be-identified materials, having been answered by an answer without doubt, the question and this answer to the question may be used as the question-and-answer material. Clustering the acquired to-be-identified materials may also include: combining questions and answers of the same type (for example, being of a university-related data type) in the to-be-identified materials, and selecting a question having a definite answer and a corresponding answer as the question-and-answer material.

Optionally, in order to ensure a reliability of the extracted question-and-answer material, for the question, in the to-be-identified materials, which is definitely indicated by a user to have been given a correct answer, the question and the answer thereof may also be used as the question-and-answer material. Based on a current question, when there is a definite response to the answer of the current question in the question-asking community, it is determined that the current question has been definitely indicated to have a correct answer. For example, the question is: What is Begonia fimbristipulata, and the answer is: Begonia fimbristipulata is a relatively precious green plant, and it can also assist in curing diseases, and a follow-up comment of confirming that the answer is correct is provided. In this example, the follow-up comment is content in which a user definitely indicates that the answer to the question is correct.

Optionally, in order to more clearly represent the question and the answer corresponding to the question, the to-be-identified materials may also include attribute information for the question and the answer corresponding to the question. The attribute information is used to identify an address, a time, a person and other information related to the question or the answer. After the to-be-identified materials are clustered, attribute information of the question-and-answer material is determined accordingly by identifying the attribute information of the to-be-identified materials, and the question-and-answer material may be effectively interpreted using the attribute information of the question-and-answer material.

Step 102, performing corpus-processing on the question-and-answer material to obtain a question-and-answer corpus pair.

The question-and-answer corpus pair includes at least one question and an answer to each question of the at least one question.

In the present embodiment, performing corpus-processing on the question-and-answer material includes:

based on a form of a current question-and-answer material (for example, a speech, or an image), the question-and-answer material may be processed to obtain a text question-and-answer corpus pair through corpus processing. That is, the question-and-answer corpus pair is a text containing a question and an answer to the question.

Optionally, when the question-and-answer material includes a text, performing corpus-processing on the question-and-answer material includes: according to a major field to which the question-and-answer material belongs, natural language processing related to the major field may be performed on the question-and-answer material, then the question-and-answer corpus pair may be obtained. For example, if the major field of the question-and-answer material is chemistry, performing corpus-processing on the question-and-answer material includes: identifying a rarely-used character for a chemical element in the question-and-answer material, and performing semantic recognition on the rarely-used character, determining semantics of the identified question-and-answer material, and obtaining the question-and-answer corpus pair based on the semantics of the question-and-answer material.

It should be noted that, based on an industry or a type of the acquired to-be-identified materials, when processing the question-and-answer material to obtain the question-and-answer corpus pair, it is necessary to consider special needs of the industry of the to-be-identified material. For example, the to-be-identified material is derived from a math forum for college students. Based on the particularity of formulas in college mathematics, when performing corpus processing on the question-and-answer material, the question-and-answer material is required to be mapped to a formula commonly used by the college students through fuzzy matching, to identify special characters in the formulas appearing in the question-and-answer material.

Optionally, after performing corpus processing on the question-and-answer material, the attribute information of the question-and-answer material may be used to determine attribute information of the question-and-answer corpus pair. In the present embodiment, the attribute information of the question-and-answer corpus pair is an address, a time, a person and other information corresponding to the question and the answer to the question in the question-and-answer corpus pair. The attribute information of the question-and-answer corpus pair may effectively interpret the question-and-answer corpus pair, and provide detailed and comprehensive information for the question-and-answer corpus pair.

Step 103, performing title determination on the question-and-answer corpus pair to obtain at least one title and an answer corresponding to each title of the at least one title.

In the present embodiment, the question-and-answer corpus pair contains at least one question. Each question in the at least one question may be a title or may not be a title. In order to obtain the title in the question-and-answer corpus pair, it is necessary to perform title determination on the question-and-answer corpus pair to select a title and the answer corresponding to the title in the question-and-answer corpus pair.

Performing title determination on the question-and-answer corpus pair may include: performing word segmentation and natural language processing on the question-and-answer corpus pair to obtain semantics of each word or character in the question-and-answer corpus pair, and determining a similarity between semantics of words or characters in a question of the question-and-answer corpus pair and a preset title common feature; when the similarity is higher than a similarity threshold (90%), determining that the question in the question-and-answer corpus pair is a title; and when the similarity is less than or equal to the similarity threshold, determining that the question in the current question-and-answer corpus pair is not a title.

The preset title common feature may be acquired by the following method: performing word segmentation and performing semantic analysis using natural language processing on a large number of labeled question-and-answer texts (manually labeled question-and-answer texts in which titles and non-titles are distinguished, where a title question-and-answer text is a positive sample, and a non-title question-and-answer text is a negative sample) in the current academic stage and current major field, collecting features for a large number of positive and negative samples respectively, obtaining common feature attributes of the title question-and-answer texts by dynamically mining, identifying feature attributes of non-titles, and extracting common features based on the common feature attributes of the title question-and-answer texts as the preset title common features.

Optionally, after obtaining the at least one title and the answer corresponding to each title of the at least one title, attribute information of the title and the answer to the title may be determined by the attribute information of the question-and-answer corpus pair. In the present embodiment, the attribute information of the title and the answer to the title is an address, a time, a person and other information for the title and the answer to the title in the question-and-answer corpus pair. The attribute information of the title and the answer to the title may effectively interpret the title and the answer to the title, and provide a comprehensive basis for generating bank information with more comprehensive question.

Step 104, storing the at least one title and an answer corresponding to each title of the at least one title in a question bank in a structured manner.

In the present embodiment, structuring of the title and the answer to the title in the question bank is determined by a storage structure of a cell in the question bank. Each cell in the question bank is provided with different fields, and the title and the answer to the title belong to different fields of the cell respectively.

As an example, a storage structure of the cell includes: a title field name, title content; an answer field name, answer content. The title and the answer to the title may be stored in the question bank through the storage structure of the cell in the question bank.

Optionally, the storage structure of the cell in the question bank may also be: a title field name, title content; an answer field name, answer content; a questioner field name, a questioner nickname; an answerer field name, an answerer nickname. In this example, by setting the questioner and answerer in the cell of the question bank, an author corresponding to the title may be definitely indicated.

Optionally, the storage structure of the cell in the question bank may also be: a title field name, title content; an answer field name, answer content; a questioner field name, a questioner name; an answerer field name, an answerer name; a time field name, a question time, an answer time. In this example, by setting the question time of the questioner and the answer time of the answerer in the cell of the question bank, the times when the title and the answer corresponding to the title are generated may be definitely indicated.

Optionally, the storage structure of the cell in the question bank may also be: a title field name, title content; an answer field name, answer content; a questioner field name, a questioner name; an answerer field name, an answerer name; a time field name, a question time, an answer time; an address field name, a questioning address, an answering address. In this example, by setting the address of the questioner and the address of the answerer in the cell of the question bank, a specific locations where the title and the answer corresponding to the title are generated may be definitely indicated, providing a basis for reliable tracing of the title.

By the method for entering information provided by the present embodiment, it is possible to automatically acquire the title, and use the acquired title to automatically and effectively expand the question bank for college students, which may greatly facilitate to improve the recall rate and accuracy of title search for college students, and expand the number of titles and types in the question bank.

In the method for entering information provided by the present embodiment of the present disclosure, firstly acquired to-be-identified materials are clustered to obtain a question-and-answer material; secondly, corpus-processing is performed on the question-and-answer material to obtain a question-and-answer corpus pair, the question-and-answer corpus pair including at least one question and an answer to each question of the at least one question; then title determination is performed on the question-and-answer corpus pair to obtain at least one title and an answer corresponding to each title of the at least one title; and finally, the at least one title and the answer corresponding to each title of the at least one title are stored in a question bank in a structured manner. As a result, by performing title determination on the question-and-answer corpus pair, the title and answer in the question-and-answer corpus pair are obtained, the content of the question bank is automatically expanded, and the recall rate and accuracy of title search are improved.

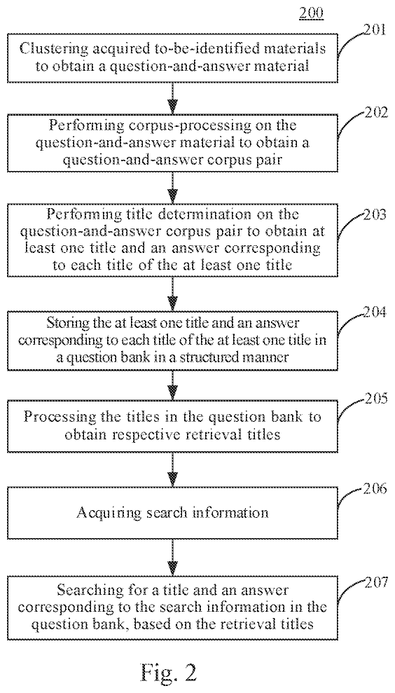

FIG. 2 shows a flow 200 of another embodiment of the method for entering information according to the present disclosure. The method for entering information includes the following steps:

Step 201, clustering acquired to-be-identified materials to obtain a question-and-answer material.

Step 202, performing corpus-processing on the question-and-answer material to obtain a question-and-answer corpus pair.

The question-and-answer corpus pair includes at least one question and an answer to each question of the at least one question.

Step 203, performing title determination on the question-and-answer corpus pair to obtain at least one title and an answer corresponding to each title of the at least one title.

Step 204, storing the at least one title and the answer corresponding to each title of the at least one title in a question bank in a structured manner.

It should be understood that the operations and features in steps 201 to 204 above correspond to the operations and features in steps 101 to 104, respectively. Therefore, the descriptions of the operations and features in steps 101 to 104 are also applicable to steps 201 to 204, and detailed description thereof will be omitted.

Step 205, processing titles in the question bank to obtain retrieval titles.

In the present embodiment, a retrieval title is a title that may be stored in a search library and obtained after keyword processing is performed on a title in the question bank. The processing to the titles in the question bank includes: performing one or more of noise removal, word segmentation, and normalization processing on the titles in the question bank to obtain the retrieval titles.

For example, if a title in the question bank is a formula for calculating a triangle area, by processing the title, the retrieval title obtained is triangle-area.

Step 206, acquiring search information.

In the present embodiment, the search information is information used to search for related content in the question bank. The search information may include: a title, an answer, a time, an address, a person, etc.

Step 207, searching for a title and an answer corresponding to the search information in the question bank, based on the retrieval titles.

In the present embodiment, the retrieval titles are pieces of information related to the titles in the question bank. For example, a retrieval title is a keyword of a title in the question bank. By a similarity comparison between the retrieval title and the search information, the title and the answer corresponding to the search information may be found in the question bank. When the similarity between the search information and the retrieval title is greater than a similarity threshold (90%), the title and the answer to the title corresponding to the retrieval title in the question bank are the title and the answer corresponding to the search information.

Optionally, the method further includes: sorting times corresponding to the titles respectively in the question bank to obtain sorted times, and using the sorted times as retrieval times respectively; when the search information includes a search time, comparing the search time with each time in the retrieval times, so that titles and answers in a result time period are used as the titles and the answers corresponding to the search information, where the result time period is obtained a preset time period relative to the search time. For example, if the search time is February 1, then the result time period is: a time period between January 31 and February 2.

In the method for entering information provided by the present embodiment of the present disclosure, by processing the titles in the question bank to obtain the retrieval titles, a reliability of information retrieval is ensured; and the search information is acquired, the title and the answer corresponding to the search information is retrieved in the question bank based on the retrieval title. It is possible to retrieve the title and the answer corresponding to the user's search information quickly and continuously in an expanded question bank according to the user requirements.

In some optional implementations of the present embodiment, clustering acquired to-be-identified materials to obtain a question-and-answer material includes: acquiring the to-be-identified materials; and clustering to-be-identified materials that meet a question-and-answer condition in the to-be-identified materials to obtain the question-and-answer material.

In the present embodiment, the to-be-identified materials may include multiple types of information, such as poems, essays, titles, etc. In order to acquire a question and an answer with the same type of information as those in the to-be-identified material and related to the question bank, it is necessary to set the question-and-answer condition to select the question-and-answer material.

The question-and-answer condition is a condition for clustering the to-be-identified materials and is also a condition for obtaining the question-and-answer material. The question-and-answer condition may include: a condition for determining questions and answers in different academic stages and professional types. For example, the question-and-answer condition is a condition of relating to college

English and being a question having a definite answer. Optinally, according to the type of the question bank (the academic stage, professional type, etc. targeted by the question bank), the question-and-answer condition may also be: a condition for determining questions and answers in different time periods and of all majors, and being question having a definite answer.

In this optional implementation, the question-and-answer material is extracted by setting the question-and-answer condition, which provides a reliable material basis for automatic entry of titles and answers to the titles in the question bank, and improves the reliability of title entry.

In some optional implementations of the present embodiment, a to-be-identified material includes a to-be-identified image and a to-be-identified text; and the clustering to-be-identified materials that meet a question-and-answer condition in the to-be-identified materials includes: clustering a to-be-identified image that meets an image question-and-answer condition in the to-be-identified images to obtain a question-and-answer image; clustering to-be-identified texts that meet a text question-and-answer condition in the to-be-identified texts to obtain a question-and-answer text; and combining the question-and-answer image and the question-and-answer text to obtain the question-and-answer material.

In this optional implementation, the image question-and-answer condition is a condition set for the to-be-identified materials in the form of an image. The text question-and-answer condition is a condition set for the to-be-identified materials in the form of text. It should be noted that the image question-and-answer condition and the text question-and-answer condition may be identical after a format conversion of the to-be-identified material. For example, the image question-and-answer condition is equivalent to the text question-and-answer condition after performing character recognition in the to-be-identified image.

In this optional implementation, when the to-be-identified material includes the to-be-identified image and the to-be-identified text, by clustering the to-be-identified images and the to-be-identified texts, respectively, the question-and-answer material is obtained, and the comprehensiveness of the question-and-answer material is ensured.

In some optional implementations of the present embodiment, the question-and-answer material includes a question-and-answer image, and performing corpus-processing on the question-and-answer material to obtain a question-and-answer corpus pair includes: removing regional noise in the question-and-answer image to obtain a noise-free image; correcting, in response to image information in the noise-free image having an inclination angle, the image information in the noise-free image to obtain a corrected image; and performing sequentially layout cutting, character recognition, and character sorting on the corrected image to obtain the question-and-answer corpus pair.

In this optional implementation, removing regional noise in the question-and-answer image includes: removing noise in a fuzzy area, “space” in the question and the answer, and removing an unrecognizable pattern in the question-and-answer image, etc.

In this optional implementation, correcting the image information in the noise-free image includes: correcting, in response to detecting that the image information in the noise-free image has an inclination angle, the noise-free image, so that the inclination angle of the image information in the noise-free image is zero, to obtain the corrected image.

In this optional implementation, performing sequentially layout cutting, character recognition, and character sorting on the corrected image (or uncorrected noise-free image) includes:

1) Layout cutting, where the corrected image (or an uncorrected noise-free image) is divided into paragraphs and cut into different lines; a part, in which a formula is located, in the corrected image (or uncorrected noise-free image) is separately cut.

2) Character recognition, where the different lines is recognized by means of feature extraction; formulas appearing in different lines are mapped to a formula library through fuzzy matching, the fomular including Greek letters, mathematical symbols, etc.; all symbols in the formula are prioritized as mathematical symbols. For example, “′” in a cut formula paragraph should be determined as a derivative symbol instead of a single quotation mark.

3) Character sorting, where a sequence of the cut paragraphs remains unchanged in accordance with the original noise-free image, and formulas are displayed separately.

In this optional implementation, by removing the noise in the question-and-answer image, correcting the angle of the image information in the noise-free image, and performing layout cutting, character recognition, and character sorting on the corrected image, it is possible to effectively and accurately identify the content of the image information in the question-and-answer image, and ensure the reliability of the extraction of the question-and-answer corpus pair.

In some optional implementations of the present embodiment, performing structured storage on each title and the answer corresponding to each title in a question bank, includes: performing structured processing on each title and the answer corresponding to each title, to obtain a title-answer group to be stored; comparing the title-answer group to be stored with a title-answer group in the question bank; and storing a title-answer group to be stored that is different from any one of the title-answer groups in the question bank into the question bank.

In this optional implementation, information is stored in the question bank with a storage structure of the question bank, and structured processing is performed on the determined title and the answer corresponding to the title, so that the determined title and the answer corresponding to the title may be transformed into the same storage structure as those in the question bank. For example, a title format in the question bank is: a title field, title content; an answer field, answer content. The determined title is performed structured processing such that the determined title has the same structure as the information in the question bank, facilitating comparison with the content in the question bank. The determined title that is identical in content with a title in the question bank is removed to ensure that identical content may not be stored in the question bank repeatedly.

In this optional implementation, by removing a title-answer group to be stored that is identical with a title-answer group in the question bank, an effect of removing duplicates is achieved, which ensures that there may be no duplicate titles and answers in the question bank, and a validity of question bank information is ensured.

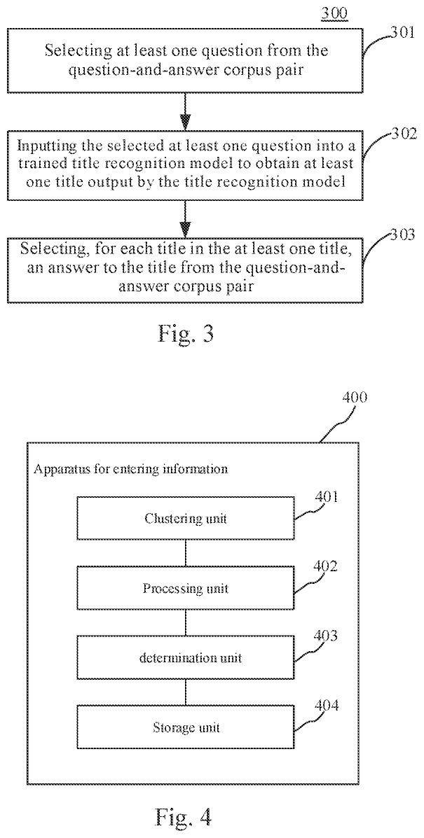

There may be a lot of interference information in the question-and-answer corpus pair, and an invalid question cannot be stored into the question bank as a title. A title recognition model needs to be built to identify whether a question raised by the user is a title, and to filter invalid information. In some optional implementations of the present embodiment, as shown in FIG. 3, a flowchart 300 of performing title determination on a question-and-answer corpus pair is illustrated, and the method for performing corpus-processing on a question-and-answer material includes the following steps:

Step 301, selecting the at least question in the question-and-answer corpus pair.

In the present embodiment, using question-related keywords in the question-and-answer corpus pair, such as “the formula is”, “what is”, the question in the question-and-answer corpus pair may be quickly determined.

Step 302, inputting the selected at least one question into a trained title recognition model to obtain at least one title output by the title recognition model.

The title recognition model is used to perform title determination on the input at least one question.

In this optional implementation, a principle of the title recognition model for title determination is: acquiring a large number of labeled questions, determining common attribute information for questions, each of which is a title, using the common attribute information as a standard, and using a large number of training samples to train the title recognition model until the title recognition model meets a training completion condition, to obtain the trained title recognition model. In this regard, the trained title recognition model uses the common attribute information of titles as a criterion to perform title determination on the input question, and outputs a confidence that the question is a title. A determining process of the model is as follows: determining a feature similarity of a question with content of a “title” type; if the feature similarity is higher than a certain threshold, the question is determined as a title, and if the feature similarity is lower than the threshold, the question is determined as a non-title.

Specifically, a process of obtaining the common attribute information of titles is as follows: performing word segmentation on a large number of labeled question-and-answer texts to obtain segmented questions, and using a natural language processing model to perform semantic analysis on the segmented questions to determine features for positive samples and those for negative samples; dynamically mining a common feature attribute of “title”-type texts; and distinguishing each unique feature attribute of “non-title”-type texts from the extracted common feature of the “title”-type texts, and using the extracted common feature as the criterion.

Specifically, a training process of using a large number of training samples to train the title recognition model is as follows:

1) collecting a large number of question-containing texts as training samples.

2) performing title feature labeling for each word in the training samples to construct a data set. For example, some words in the questions belong to the common feature attributes, or some words in the questions belong to unique feature attributes.

3) using a model structure such as a convolutional neural network to build the title recognition model, and then using the collected training samples to train the title recognition model. In the training process, an error of the title recognition model may be determined based on a difference between a detection result of feature attributes of words of the training sample by the title recognition model and labelling information of feature attributes of the training sample, and an error back propagation method may be used to perform iteration to adjust parameters of the title recognition model, so as to gradually reduce the error. When the error of the title recognition model converges to a certain range or the number of iteration times reaches a preset number threshold, the parameter adjustment may be stopped, and the trained title recognition model may be obtained.

It should be noted that before inputting the selected question into the trained title recognition model, filtering, word segmentation, stop-word removal and other processing need to be performed on the selected question sequentially. Here, filtering the selected question includes: automatically determining a question that contains less than a set number (for example, 5) of characters in the selected question as an invalid question and filtering out this question. Performing word segmentation on the selected question includes: segmenting the selected question into words. Performing stop-word removal includes: creating a stop-word database to filter out an invalid word in the question obtained after the word segmentation, such as a title number, or a title-type prefix.

Optionally, after obtaining the trained title recognition model, manual evaluation may be used to continuously optimize the title recognition model and adjust each feature threshold. After the title recognition model is built, the title recognition model is continuously fed back through manual labeling, to optimize a determination threshold of each feature of the title to ensure the accuracy of title determination.

Step 303, selecting, for each title in the at least one title, an answer to the title from the question-and-answer corpus pair.

In this optional implementation, since the question has been selected in the question-and-answer corpus pair, remaining content of the question-and-answer corpus pair is the answer corresponding to the question.

In this optional implementation, the question in the question-and-answer corpus pair is recognized using the title recognition model, and a result of whether the question in the question-and-answer corpus pair is a title is obtained. The title recognition model may be optimized based on manual labeling feedback, which improves the accuracy of title determination and ensures the reliability of the title acquired from the question-and-answer corpus pair.

With further reference to FIG. 4, as an implementation of the method shown in the above figures, the present disclosure provides an embodiment of an apparatus for entering information, and the apparatus embodiment corresponds to the method embodiment as shown in FIG. 1, and the apparatus may be applied to various electronic devices.

As shown in FIG. 4, the apparatus 400 for entering information provided by the present embodiment includes: a clustering unit 401, a processing unit 402, a determination unit 403, a storage unit 404. The clustering unit 401 may be configured to cluster acquired to-be-identified materials to obtain a question-and-answer material. The processing unit 402 may be configured to perform corpus-processing on the question-and-answer material to obtain a question-and-answer corpus pair, the question-and-answer corpus pair comprising at least one question and an answer to each question of the at least one question. The determination unit 403 may be configured to perform title determination on the question-and-answer corpus pair to obtain at least one title and an answer corresponding to each title of the at least one title. The storage unit 404 may be configured to store the at least one title and an answer corresponding to each title of the at least one title in a question bank in a structured manner.

In the present embodiment, in the apparatus 400 for entering information: for the specific processing and the technical effects of the clustering unit 401, the processing unit 402, the determination unit 403, and the storage unit 404, reference may be made to the relevant descriptions of step 101, step 102, step 103, and step 104 in the embodiment corresponding to FIG. 1 respectively, and detailed description thereof will be omitted.

In some optional implementations of the present embodiment, the apparatus 400 further includes: a retrieve unit (not shown in the figure), an acquisition unit (not shown in the figure), and a search unit (not shown in the figure). The retrieve unit may be configured to process titles in the question bank to obtain respective retrieval titles. The acquisition unit may be configured to acquire search information. The search unit may be configured to search for a title and an answer corresponding to the search information in the question bank, based on the retrieval titles.

In some optional implementations of the present embodiment, the clustering unit 401 includes: an acquisition module (not shown in the figure), and a clustering module (a clustering module). The acquisition module may be configured to acquire the to-be-identified materials. The clustering module may be configured to cluster to-be-identified materials that meet a question-and-answer condition in the to-be-identified materials to obtain the question-and-answer material.

In some optional implementations of the present embodiment, the to-be-identified materials comprises to-be-identified images and to-be-identified texts; and the clustering module includes: an image clustering submodule (not shown in the figure), a text clustering submodule (not shown in the figure), a combination submodule (not shown in the figure). The image clustering submodule may be configured to cluster to-be-identified images that meet an image question-and-answer condition in the to-be-identified images to obtain a question-and-answer image. The text clustering submodule may be configured to cluster to-be-identified texts that meet a text question-and-answer condition in the to-be-identified texts to obtain a question-and-answer text. The combination submodule may be configured to combine the question-and-answer image and the question-and-answer text to obtain the question-and-answer material.

In some optional implementations of the present embodiment, the question-and-answer material includes: a question-and-answer image, and the processing unit 402 includes: a removing module (not shown in the figure), a correction module (not shown in the figure), a processing module (not shown in the figure). The removing module may be configured to remove regional noise in the question-and-answer image to obtain a noise-free image. The correction module may be configured to correct, in response to image information in the noise-free image having an inclination angle, the image information in the noise-free image to obtain a corrected image. The processing module may be configured to perform layout cutting, character recognition, and character sorting on the corrected image sequentially, to obtain the question-and-answer corpus pair.

In some optional implementations of the present embodiment, the determination unit 403 includes: a selection module (not shown in the figure), an input module (not shown in the figure), an answer selection module (not shown in the figure). The selection module may be configured to select the at least one question from the question-and-answer corpus pair. The input module may be configured to input the selected at least one question into a trained title recognition model to obtain at least one title output by the title recognition model, the title recognition model being used to perform title determination on the input at least one question. The answer selection module may be configured to select, for each title in the at least one title, an answer to the title from the question-and-answer corpus pair.

In some optional implementations of the present embodiment, the storage unit 404 includes: a formatting module (not shown in the figure), a comparing module (not shown in the figure), a storing module (not shown in the figure). The formatting module may be configured to perform structuring processing on the at least one title and the answer corresponding to each title of the at least one title, to obtain at least one title-answer group to be stored. The comparing module may be configured to compare each title-answer group in the at least one title-answer group to be stored with a title-answer group of title-answer groups in the question bank. The de-weighting module may be configured to store, into the question bank, a title-answer group to be stored that is different from any one of title-answer groups in the question bank.

The apparatus for entering information provided by the embodiments of the present disclosure, first the clustering unit 401 clusters acquired to-be-identified materials to obtain a question-and-answer material;

secondly the processing unit 402 performs corpus-processes on the question-and-answer materials to obtain a question-and-answer corpus pair, the question-and-answer corpus pair including at least one question and an answer to each question of the at least one question; then the determination unit 403 performs title determination on the question-and-answer corpus pair to obtain at least one title and an answer corresponding to each title of the at least one title; and finally the storage unit 404 store the at least one title and an answer corresponding to each title of the at least one title in a question bank in a structured manner. As a result, by perform title determination on the question-and-answer corpus pair, the title and answer in the question-and-answer corpus pair are obtained, the content of the question bank is automatically expanded, and the recall rate and accuracy of title search are improved.

In the technical solution of the present disclosure, the acquisition, storage, and application of user personal information involved are in compliance with relevant laws and regulations, and do not violate public order and good customs.

According to an embodiment of the present disclosure, the present disclosure also provides an electronic device, a readable storage medium, and a computer program product.

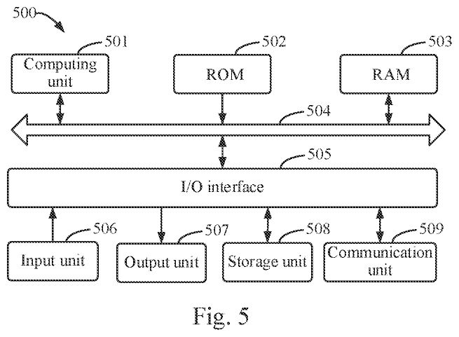

FIG. 5 shows a schematic block diagram of an example electronic device 500 that can be used to implement embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may also represent various forms of mobile apparatuses such as personal digital processing, a cellular telephone, a smart phone, a wearable device and other similar computing apparatuses. The parts shown herein, their connections and relationships, and their functions are only as examples, and not intended to limit the implementations of the present disclosure as described and/or claimed herein.

As shown in FIG. 5, the device 500 may include a computing unit 501, which may execute various appropriate actions and processes in accordance with a program stored in a read-only memory (ROM) 502 or a program loaded into a random access memory (RAM) 503 from a storage apparatus 508. The RAM 503 also stores various programs and data required by operations of the device 500. The computing unit 501, the ROM 502 and the RAM 503 are connected to each other through a bus 504. An input/output (I/O) interface 505 is also connected to the bus 504.

Multiple components in the device 500 are connected to the I/O interface 505, including: an input unit 506 including a touch screen, a touchpad, a keyboard, a mouse and the like; an output unit 507, such as various types of displays, a speaker, and the like; a storage unit 508 including a magnetic tap, a hard disk and the like; and a communication unit 509. The communication unit 509 may allow the electronic device 500 to perform wireless or wired communication with other devices to exchange data.

The computing unit 501 may be various general-purpose and/or dedicated processing components having processing and computing capabilities. Some examples of the computing unit 501 include, but are not limited to, central processing unit (CPU), graphics processing unit (GPU), various dedicated artificial intelligence (AI) computing chips, various computing units running machine learning model algorithms, digital signal processor (DSP), and any appropriate processors, controllers, microcontrollers, etc. The computing unit 501 performs the various methods and processes described above, such as the method for entering information. For example, in some embodiments, the method for entering information may be implemented as a computer software program, which is tangibly included in a machine readable medium, such as the storage unit 508. In some embodiments, part or all of the computer program may be loaded and/or installed on the device 500 via the ROM 502 and/or the communication unit 509. When the computer program is loaded into the RAM 503 and executed by the computing unit 501, one or more steps of the method for entering information described above may be performed. Alternatively, in other embodiments, the computing unit 501 may be configured to perform the method for entering information by any other appropriate means (for example, by means of firmware).

Various embodiments of the systems and technologies described in this article may be implemented in digital electronic circuit systems, integrated circuit systems, field programmable gate arrays (FPGA), application specific integrated circuits (ASIC), application-specific standard products (ASSP), system-on-chip (SOC), complex programmable logic device (CPLD), computer hardware, firmware, software, and/or their combinations. These various embodiments may include: being implemented in one or more computer programs, the one or more computer programs may be executed and/or interpreted on a programmable system including at least one programmable processor, the programmable processor may be a dedicated or general-purpose programmable processor that may receive data and instructions from a storage system, at least one input apparatus, and at least one output apparatus, and transmit the data and instructions to the storage system, the at least one input apparatus, and the at least one output apparatus.

Program codes for implementing the method of the present disclosure may be written in any combination of one or more programming languages. These program codes may be provided to a processor or controller of a general purpose computer, special purpose computer or other programmable data processing apparatus such that the program codes, when executed by the processor or controller, enables the functions/operations specified in the flowcharts and/or block diagrams being implemented. The program codes may execute entirely on the machine, partly on the machine, as a stand-alone software package partly on the machine and partly on the remote machine, or entirely on the remote machine or server.

In the context of the present disclosure, the machine readable medium may be a tangible medium that may contain or store programs for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, portable computer disk, hard disk, random access memory (RAM), read only memory (ROM), erasable programmable read only memory (EPROM or flash memory), optical fiber, portable compact disk read only memory (CD-ROM), optical storage device, magnetic storage device, or any suitable combination of the foregoing.

In order to provide interaction with a user, the systems and technologies described herein may be implemented on a computer, the computer has: a display apparatus (e.g., CRT (cathode ray tube) or LCD (liquid crystal display) monitor for displaying information to the user; and a keyboard and a pointing apparatus (for example, a mouse or trackball), the user may use the keyboard and the pointing apparatus to provide input to the computer.

Other kinds of apparatuses may also be used to provide interaction with the user; for example, the feedback provided to the user may be any form of sensory feedback (for example, visual feedback, auditory feedback, or tactile feedback); and may use any form (including acoustic input, voice input, or tactile input) to receive input from the user.

The systems and technologies described herein may be implemented in a computing system (e.g., as a data server) that includes back-end components, or a computing system (e.g., an application server) that includes middleware components, or a computing system (for example, a user computer with a graphical user interface or a web browser, through which the user may interact with the embodiments of the systems and technologies described herein) that includes front-end components, or a computing system that includes any combination of such back-end components, middleware components, or front-end components. The components of the system may be interconnected by any form or medium of digital data communication (e.g., a communication network). Examples of the communication network include: local area network (LAN), wide area network (WAN), and Internet.

The computer system may include a client and a server. The client and the server are generally far from each other and usually interact through a communication network. The client and server relationship is generated by computer programs operating on the corresponding computer and having client-server relationship with each other. The server can be a cloud server, a server for a distributed system, or a server combined with blockchain.

It should be understood that various forms of processes shown above may be used to reorder, add, or delete steps. For example, the steps described in the present disclosure may be performed in parallel, sequentially, or in different orders, as long as the desired results of the technical solution disclosed in embodiments of the present disclosure can be achieved, no limitation is made herein.

The above specific embodiments do not constitute a limitation on the protection scope of the present disclosure. Those skilled in the art should understand that various modifications, combinations, sub-combinations and substitutions can be made according to design requirements and other factors. Any modification, equivalent replacement and improvement made within the spirit and principle of the present disclosure shall be included in the protection scope of the present disclosure.

What is claimed is:

1. A method for entering information, the method comprising:
clustering acquired to-be-identified materials to obtain a question-and-answer material;
performing corpus-processing on the question-and-answer material to obtain a question-and-answer corpus pair, the question-and-answer corpus pair comprising at least one question and an answer to each question of the at least one question;
performing title determination on the question-and-answer corpus pair to obtain at least one title and an answer corresponding to each title of the at least one title; and
storing the at least one title and an answer corresponding to each title of the at least one title in a question bank in a structured manner.

2. The method according to claim 1, wherein the question bank comprises titles and answers corresponding to the titles respectively, and the method further comprises:
processing the titles in the question bank to obtain respective retrieval titles;
acquiring search information; and
searching for a title and an answer corresponding to the search information in the question bank, based on the retrieval titles.

3. The method according to claim 1, wherein clustering the acquired to-be-identified materials to obtain a question-and-answer material, comprises:
acquiring the to-be-identified materials; and
clustering to-be-identified materials that meet a question-and-answer condition in the to-be-identified materials to obtain the question-and-answer material.

4. The method according to claim 3, wherein the to-be-identified materials comprises to-be-identified images and to-be-identified texts; and clustering to-be-identified materials that meet the question-and-answer condition in the to-be-identified materials comprises:
clustering to-be-identified images that meet an image question-and-answer condition in the to-be-identified images to obtain a question-and-answer image; and
clustering to-be-identified texts that meet a text question-and-answer condition in the to-be-identified texts to obtain a question-and-answer text; and
combining the question-and-answer image and the question-and-answer text to obtain the question-and-answer material.

5. The method according to claim 1, wherein the question-and-answer material comprises a question-and-answer image, and performing corpus-processing on the question-and-answer material to obtain a question-and-answer corpus pair comprises:
removing regional noise in the question-and-answer image to obtain a noise-free image;
correcting, in response to image information in the noise-free image having an inclination angle, the image information in the noise-free image to obtain a corrected image; and
performing layout cutting, character recognition, and character sorting on the corrected image sequentially, to obtain the question-and-answer corpus pair.

6. The method according to claim 1, wherein performing title determination on the question-and-answer corpus pair to obtain at least one title and an answer corresponding to each title of the at least one title, comprises:
selecting the at least one question from the question-and-answer corpus pair;
inputting the selected at least one question into a trained title recognition model to obtain at least one title output by the title recognition model, the title recognition model being used to perform title determination on the input at least one question; and
selecting, for each title in the at least one title, an answer to the title from the question-and-answer corpus pair.

7. The method according to claim 1, wherein storing the at least one title and an answer corresponding to each title of the at least one title in a question bank in a structured manner, comprises:
performing structuring processing on the at least one title and the answer corresponding to each title of the at least one title, to obtain at least one title-answer group to be stored;
comparing each title-answer group to be stored in the at least one title-answer group to be stored with a title-answer group of title-answer groups in the question bank; and
storing, into the question bank, a title-answer group to be stored that is different from any one of title-answer groups in the question bank.

8. An apparatus for entering information, the apparatus comprising:
at least one processor; and
a memory storing instructions, wherein the instructions when executed by the at least one processor, cause the at least one processor to perform operations, the operations comprising:
clustering acquired to-be-identified materials to obtain a question-and-answer material;
performing corpus-processing on the question-and-answer material to obtain a question-and-answer corpus pair, the question-and-answer corpus pair comprising at least one question and an answer to each question of the at least one question;
performing title determination on the question-and-answer corpus pair to obtain at least one title and an answer corresponding to each title of the at least one title; and
storing the at least one title and an answer corresponding to each title of the at least one title in a question bank in a structured manner.

9. The apparatus according to claim 8, wherein the question bank comprises titles and answers corresponding to the titles respectively, and the operations further comprise:
processing the titles in the question bank to obtain respective retrieval titles;
acquiring search information; and
searching for a title and an answer corresponding to the search information in the question bank, based on the retrieval titles.

10. The apparatus according to claim 8, wherein the operations comprise:
acquiring the to-be-identified materials; and
clustering to-be-identified materials that meet a question-and-answer condition in the to-be-identified materials to obtain the question-and-answer material.

11. The apparatus according to claim 10, wherein the to-be-identified materials comprises to-be-identified images and to-be-identified texts; and the operations comprise:
clustering to-be-identified images that meet an image question-and-answer condition in the to-be-identified images to obtain a question-and-answer image; and
clustering to-be-identified texts that meet a text question-and-answer condition in the to-be-identified texts to obtain a question-and-answer text; and
combining the question-and-answer image and the question-and-answer text to obtain the question-and-answer material.

12. The apparatus according to claim 8, wherein the question-and-answer material comprises: a question-and-answer image, and the operations comprise:
removing regional noise in the question-and-answer image to obtain a noise-free image;
correcting, in response to image information in the noise-free image having an inclination angle, the image information in the noise-free image to obtain a corrected image; and
performing layout cutting, character recognition, and character sorting on the corrected image sequentially, to obtain the question-and-answer corpus pair.

13. The apparatus according to claim 8, wherein the operations comprise:
selecting the at least one question from the question-and-answer corpus pair;
inputting the selected at least one question into a trained title recognition model to obtain at least one title output by the title recognition model, the title recognition model being used to perform title determination on the input at least one question; and
selecting, for each title in the at least one title, an answer to the title from the question-and-answer corpus pair.

14. The apparatus according to claim 8, wherein the operations comprise:
performing structuring processing on the at least one title and the answer corresponding to each title of the at least one title, to obtain at least one title-answer group to be stored;
comparing each title-answer group to be stored in the at least one title-answer group to be stored with a title-answer group of title-answer groups in the question bank; and
storing, into the question bank, a title-answer group to be stored that is different from any one of title-answer groups in the question bank.

15. A non-transitory computer readable storage medium, storing computer instructions, the computer instructions, being used to cause the computer to perform operations comprising:
clustering acquired to-be-identified materials to obtain a question-and-answer material;
performing corpus-processing on the question-and-answer material to obtain a question-and-answer corpus pair, the question-and-answer corpus pair comprising at least one question and an answer to each question of the at least one question;
performing title determination on the question-and-answer corpus pair to obtain at least one title and an answer corresponding to each title of the at least one title; and
storing the at least one title and an answer corresponding to each title of the at least one title in a question bank in a structured manner.

16. The non-transitory computer readable storage medium according to claim 15, wherein the question bank comprises titles and answers corresponding to the titles respectively, and the operations further comprise:
processing the titles in the question bank to obtain respective retrieval titles;
acquiring search information; and
searching for a title and an answer corresponding to the search information in the question bank, based on the retrieval titles.

17. The non-transitory computer readable storage medium according to claim 15, the operations further comprising:
acquiring the to-be-identified materials; and
clustering to-be-identified materials that meet a question-and-answer condition in the to-be-identified materials to obtain the question-and-answer material.

18. The non-transitory computer readable storage medium according to claim 17, wherein the to-be-identified materials comprises to-be-identified images and to-be-identified texts; and the operations further comprise:
clustering to-be-identified images that meet an image question-and-answer condition in the to-be-identified images to obtain a question-and-answer image; and
clustering to-be-identified texts that meet a text question-and-answer condition in the to-be-identified texts to obtain a question-and-answer text; and
combining the question-and-answer image and the question-and-answer text to obtain the question-and-answer material.

19. The non-transitory computer readable storage medium according to claim 15, wherein the question-and-answer material comprises a question-and-answer image, and the operations further comprise:
removing regional noise in the question-and-answer image to obtain a noise-free image;
correcting, in response to image information in the noise-free image having an inclination angle, the image information in the noise-free image to obtain a corrected image; and
performing layout cutting, character recognition, and character sorting on the corrected image sequentially, to obtain the question-and-answer corpus pair.

20. The non-transitory computer readable storage medium according to claim 15, the operations further comprising:
selecting the at least one question from the question-and-answer corpus pair;
inputting the selected at least one question into a trained title recognition model to obtain at least one title output by the title recognition model, the title recognition model being used to perform title determination on the input at least one question; and
selecting, for each title in the at least one title, an answer to the title from the question-and-answer corpus pair.
